(19) United States
(12) Patent Application Publication
(10) Pub. No.: US 2008/0221729 A1
(43) Pub. Date: Sep. 11, 2008

(54) Automatic Surface-Scanning Method and System

(76) Inventor: Erwann Lavarec, Montpellier (FR)

Correspondence Address: FULBRIGHT & JAWORSKI, LLP, 666 FIFTH AVE, NEW YORK, NY, 10103-3198, US

(21) Appl. No.: 10/578,235

(22) PCT Filed: Oct. 19, 2004
(86) PCT No.: PCT/FR04/50517

§ 371 Date: Apr. 11, 2007

(30) Foreign Application Priority Data
Nov. 3, 2003 (FR) 0350778

(51) Int. Cl. G06F 17/00; G05D 1/02

(52) U.S. Cl. 700/245; 701/27; 901/1

(57) ABSTRACT

The invention relates to a method of scanning a complex surface (100) defined at least partially by a physical barrier (102) and/or obstacles. The inventive method comprises: a step which is used to detect said physical barrier (102) and/or obstacles, and an initial step which is intended to calculate the length (L₀) of an initialisation strip. The method involves the use of an iterative process consisting in first travelling along the initialisation strip and continuing with other strips known as the preceding strip (118ₚ, 120ₚ), the current strip (118_{c}, 120_{c}) and the next strip (118ₛ, 120ₛ), the first preceding strip (118ₚ) being formed by the initialisation strip (118ᵢ), such as to scan the complex surface.

### AREA OF THE INVENTION

This present invention concerns the area of robotics. More particularly it concerns a process and a system implemented by a mobile robot designed to scan a complex surface, that is to traverse this complex surface in an independent manner in a sufficiently exhaustive manner to effect a treatment of the latter during this journey.

### THE PROBLEM, AND PRIOR ART

In many applications, particularly in the area of domestic and garden equipment, it is necessary to design independent equipment, such as vacuum cleaning robots, known in what follows as mobile robots, capable of traversing, in a virtually exhaustive manner, a complex surface that includes obstacles (such as the floor of a furnished room).

To this end, we are familiar with systems and procedures for the traversing of complex surfaces employing sensors used to scan the environment (particularly the walls of the room and the furniture located within it) and to record the relative position of the robot in relation to this environment.

However, in order for a robot to effect an exhaustive scan of a surface to be treated, it is necessary that it can be fitted with sensors that supply its absolute position. Now given their purchase price, such absolute position sensors are not very suitable for the creation of equipment designed for mass production.

Furthermore, we are also familiar with computing systems which determine the location of a mobile robot by integrating a series of relative positions of this robot from an initial position.

At this stage, it should be noted that the integration of successive positions is effected by odometry (dead reckoning), that is by making use of the parameters measured on the robot, such as the number of wheel revolutions of the robot and the angles of rotation of its directional wheels, in order to determine its movement in relation to an initial point.

However the systems calculating the location of a robot by integrating a series of relative positions have the disadvantage of accumulating errors over time. The result is that after a certain distance, the absolute location includes an error arising mainly from integrating noise from the sensors used.

Finally, it should be noted that low-noise sensors do exist but given their purchase price, these sensors are not very suitable for the creation of equipment designed for mass production.

### THE INVENTION

The precise purpose of this invention is to create systems and procedures for the traversing of complex surfaces by the use of low-cost relative position sensors, despite the technical drawbacks of the latter as described above.

### THE SOLUTION

The invention concerns a process for scanning a complex surface which is delimited at least in part by a physical barrier and/or obstacles, where this process includes the following stages:
a) a stage to detect the physical barrier and/or the obstacles,
b) an initial stage whose purpose is:
   either (i) to traverse, in a first direction, at least in part, an initialisation strip running along the physical barrier (scanning this strip), until the physical barrier presents an angular rupture whose value is outside the limits of a predetermined range of permitted values, and then (ii) to traverse in the other direction, in its totality, the initialisation strip running along at least one part of the physical barrier until this physical barrier presents an angular rupture whose value is outside the limits of a predetermined range of permitted values,
   or, wherever possible, to traverse in a single run a initialisation strip running along at least one part of the physical barrier contained between two angular ruptures of the physical barrier whose values fall outside the limits of a predetermined range of permitted values.

The process according to the invention also includes, during the initial stage, a stage for calculating the length (Lo) of the initialisation strip from the geometrical data (angles and lengths) characterising the geometry of the initialisation strip.

Then the process executes an iterative process which is initialised by the journey over the initialisation strip, which is then followed by the scanning of strips hereafter referred to as the previous strip, the current strip and the next strip, with the first previous strip being composed of the initialisation strip.

The initialisation, current, previous and following strips have a predetermined width (d). The parts of the complex surface scanned during the stages preceding the current stage are assumed to be located within the physical barrier delimiting the complex surface.
c) The process also includes the following successive stages:
   c1) a stage to predetermine the length (L*i) of the current strip from the geometrical data characterising the geometry of the previous strip,
   c2) a stage to traverse the current strip in its entirety running along the previous strip until the current strip presents an angular rupture whose value is outside the limits of a predetermined range of permitted values,
   c3) a stage to determine the length (Li) of the current strip from the geometrical data obtained during the journey over the current strip, where these geometrical data characterise the geometry of the current strip,
   c4) a stage to compare the predetermined length (L*i) with the determined length (Li) so that:
if the predetermined length (L*i) is more or less equal to the determined length (Li), then stage c5) of the above-detailed process is implemented,
if the predetermined length is greater than the determined length, it is assumed that an obstacle is present on the current strip, and stage c6), detailed above, is implemented,
if the predetermined length is less than the determined length, it is assumed that the physical barrier comprises a discontinuity in the said current strip and stage c7), detailed above, is implemented.
   c5) this stage consists (i) of passing to the next strip by laterally offsetting the trajectory over a distance that is more or less equal to the predetermined width (d) of a current strip, and then (ii) traversing the next strip in the direction opposite to that of the current strip, and (iii) iterating the process from stage c1). The former current strip is now considered to be the new previous strip, while the next strip is now considered to be the new current strip.
   c6) this stage breaks down into the following two options:
If the obstacle extends over the width of the current strip, then stage c6) includes (i) the operation of passing to the next strip by laterally offsetting the trajectory over a distance that is more or less equal to the predetermined width (d) of a current strip, (ii) scanning of the next strip in the direction opposite to that of the current strip, and (iii) iteration of the process from stage c1). The former current strip is now considered to be the new previous strip while the next strip is now considered to be the new current strip.
If the obstacle does not extend over the whole width of the current strip, then stage c6) includes the operations (i) of getting around the obstacle by continuing the journey over the current strip and (ii) iterating the process from stage c3).
   c7) this stage includes a stage for continuing the journey over the current strip, running along the physical barrier and following the discontinuity until an angular rupture is encountered whose value is outside the limits of a predetermined range of permitted values.

From then on, stage c7) continues in one of two options:
Option 1: if the angular rupture thus encountered corresponds to a peripheral barrier (formed by a physical barrier or an obstacle) which presents a concave feature, this concave feature is entered and the process is iterated from a), or

It has been indicated previously that “the parts of the complex surface scanned during the stages preceding the current stage are assumed to be located within the physical barrier delimiting the complex surface”. The consequence of this is that the physical barrier is assumed to follow the outer edge of the previous strip. This consideration is used to clarify the direction of stage a) “—a) is a stage to detect the physical barrier and/or the obstacles”.

In fact, it needs to be understood that stage a) also includes the detection of a previous strip, scanned previously. A previously-scanned previous strip is treated as a physical barrier.

Option 2: if the angular rupture thus encountered corresponds to a peripheral barrier that does not have a concave feature, the process is iterated from stage c1).

In the sense of this present invention, we consider that the mobile robot encounters an “angular rupture”:

(i) when the mobile robot 600 (FIG. 6a) encounters a part 602 of the physical barrier, an obstacle or a part of one of the previous strips forming an angle α between the direction 601 followed by the mobile robot and the tangent 603 to the meeting point of the robot with the part of the physical barrier or with the obstacle or with the part of one of the previous strips whose absolute value is greater than a set threshold (30°, for example), or

(ii) when the mobile robot 600 (FIG. 6b), running along a part 602 of the physical barrier, of the obstacle or of the previous strip, loses its proximity with the physical barrier, the obstacle or the previous strip along which it is running, and when correlatively the tangent 603 to the part 602 of the physical barrier or the obstacle or the previous strip followed forms an angle α with the direction 601 of the robot that is greater than a set threshold (30° for example).

Furthermore, in the sense of this present invention, we consider that the mobile robot loses its proximity when the distance between the physical barrier and the current strip increases or when the distance between the obstacle and the current strip increases or when the distance between the previous strip and the current strip increases.

It has been indicated previously that “the parts of the complex surface scanned during the stages preceding the current stage are assumed to be located within the physical barrier delimiting the complex surface”. The consequence of this is that the physical barrier is assumed to follow the outer edge of the previous strip. This consideration is used to simplify the definition of the notion of “angular rupture”, which can then be written as follows:

We consider that the mobile robot encounters an “angular rupture”:

(i) when the mobile robot encounters a part of the physical barrier or an obstacle forming a angle between the direction followed by the mobile robot and the tangent to the meeting point of the robot with the part of the physical barrier or with the obstacle, whose absolute value is greater than a set threshold (30° for example), or

(ii) when the mobile robot, running along the physical barrier or obstacle loses its proximity with the physical barrier or the obstacle along which it is running, and when correlatively the tangent to the physical barrier or the obstacle followed, forms an angle with the direction of the robot which is greater than a set threshold (such as 30°).

In the sense of this present invention, a peripheral barrier (a physical barrier or an obstacle) is said to have a concave shape if the angle between the tangent to the peripheral barrier and the direction of progression of the robot has an absolute value that is greater than a set threshold, and if by continuing its progression in its initial direction for a predetermined length, then the robot increases the distance between itself and the peripheral barrier outside of a set threshold.

According to one implementation, the process also includes a stage for passing from the current strip to the next strip by running along the physical barrier for a distance corresponding to the width of a strip, allowing for the local geometrical features of the physical barrier.

In one implementation, the geometrical data characterising the geometry of the physical barrier and/or the obstacles, the geometry of the initialisation strip, the geometry of the previous strip, the geometry of the current strip, and the geometry of the next strip, are deduced at least in part from a map of at least one part of the complex surface, the obstacles and the physical barriers.

In one implementation, the map of the complex surface, of the obstacles and of the physical barriers is created in a dynamic manner while scanning the complex surface.

The invention also concerns a system for scanning a complex surface which is delimited at least in part by a physical barrier and/or by obstacles.

The system includes a mobile robot that includes detection resources employed to (i) detect the physical barrier and/or the obstacles and (ii) to supply, at least in part, the geometrical data (angles and lengths characterising the geometry of the physical barrier and/or (iii) the geometry of the obstacles, as well as (iv) the geometry of the journey effected by the mobile robot.

The robot includes computer processing resources that are used to control the movements of the mobile robot as a function of the data supplied by the detection resources. The computer processing resources include computing resources which are used to execute an algorithm that includes the following stages:
a) a stage to control the movement of the mobile robot the physical barrier after detection of the latter by the detection resources,
b) an initial stage whose purpose is,
   that is to command the mobile robot (i to scan, in a first direction, at least in part, an initialisation strip running along the physical barrier (scanning the strip), until the physical barrier presents an angular rupture whose value is outside the limits of a range of predetermined permitted values, and then (ii) to command the mobile robot to traverse the initialisation strip in its entirety, in the other direction, running along at least one part of the physical barrier until the physical barrier presents an angular rupture whose value is outside the limits of a predetermined range of permitted values, or, as far as possible, to command the mobile robot to scan an initialisation strip in a single run running along at least one part of the physical barrier contained between two angular ruptures of the physical barrier, whose values fall outside the limits of a predetermined range of permitted values.

The computing resources are also used, during the initial stage, to calculate the length of the initialisation strip from the geometrical data (angles and lengths supplied by the detection resources, and characterising the geometry of the initialisation strip.

In addition, the computer processing resources are used to execute an iterative process initialised by the journey over the initialisation strip, and continuing by the journey over strips that are hereafter described as the previous strip, the current strip and the next strip. The first previous strip is composed of the initialisation strip. The initialisation strips, the current strips, the previous strips and the next strips have a predetermined width (d).

The computing resources are used (i) to determine the part of the complex surface remaining to be scanned by extracting the parts of the complex surface already scanned and (ii) then updating the geometrical characteristics of the physical barrier delimiting the part of the complex surface remaining to be scanned.
c) the computer processing resources include computing resources which are used also to execute the following stages of the algorithm, namely:
   c1) a stage to predetermine the length (L*i) of the current strip from the geometrical data characterising the geometry of the previous strip,
   c2) a stage to command the mobile robot to traverse the current strip in its entirety running along the previous strip, until the current strip presents an angular rupture whose value is outside the limits of a predetermined range of permitted values,
   c3) a stage to determine the length (Li) of the current strip from the geometrical data obtained during the journey over the current strip and characterising the geometry of the current strip,
   c4) a stage to compare the predetermined length (L*i) with the determined length (Li), so that

if the predetermined length (L*i) is more or less equal to the determined length (Li), stage c5) of the algorithm is executed,

if the predetermined length is greater than the determined length, it is assumed that an obstacle is present on the current strip and stage c6) of the algorithm is executed,

if the predetermined length is less than the determined length, it is assumed that the physical barrier comprises a discontinuity in the said current strip and stage c7) of the algorithm is executed.

Stages c5), c6) and c7) are detailed above.

Stage c5) includes:
a stage to command the mobile robot to pass to the next strip by laterally offsetting its trajectory over a distance that is more or less equal to the predetermined width (d) of one of the current strips,
a stage to command the mobile robot to cover the next strip in the direction opposite to that of the current strip,
a stage to command the mobile robot to iterate the algorithm from stage c1).

The former current strip is now considered to be the new previous strip, while the next strip is now considered to be the new current strip.

Stage c6) breaks down into two options, namely:
If the obstacle extends over the width (d) of the current strip, then stage c6) includes:
a stage to command the mobile robot to pass to the next strip by laterally offsetting its trajectory over a distance that is more or less equal to the predetermined width (d) of one of the current strips,
a stage to command the mobile robot to traverse the next strip in the direction opposite to that of the current strip,
a stage to command the mobile robot to iterate the algorithm from the stage c1).

The former current strip is now considered to be the new previous strip while the next strip is now considered to be the new current strip.

If the obstacle does not extend over the whole the width of the current strip, then stage c6 includes:
a stage to command the mobile robot to skirt the obstacle by continuing the journey over the current strip,
a stage to command the mobile robot to iterate the algorithm from stage c3).

Stage c7) includes:
a stage to command the mobile robot to continue the journey over the current strip, running along the physical barrier following the discontinuity until an angular rupture is encountered whose value is outside the limits of a predetermined range of permitted values,
   If the angular rupture thus encountered corresponds to a peripheral barrier that has a concave feature, then stage c7) includes a stage to command the mobile robot to enter the concave feature and to iterate the algorithm from stage a.
   If the angular rupture thus encountered corresponds to a peripheral barrier with a convex shape, then stage c7) includes a stage to command the mobile robot to iterate the algorithm from stage c1).

In one implementation of the system, the processing resources also order the mobile robot to pass from the current strip to the next strip running along the physical barrier over a distance corresponding to the width of a strip, allowing for the local geometrical features of the physical barrier.

According to one implementation of the system, the computer processing resources are used to determine the geometrical data characterising the geometry of the physical barrier and/or of the obstacles, the geometry of the initialisation strip, of the previous strip, of the current strip, and of the next strip, by deducing these, at least in part, from a map of at least one part of the complex surface, the obstacles and the physical barriers.

According to one implementation of the system, the computing resources are used to calculate, in a dynamic manner, a map of the complex surface from data supplied by the detection resources while scanning the complex surface.

In one implementation of the system, the detection resources include:
an infrared radiation emitter,
an infrared radiation receiver detecting the infrared radiation reflected by the concerned parts of the physical barrier or of the obstacle.

The computer processing resources are used to gradually vary the power of the infrared radiation sent out by the emitter up to a power that is sufficient to detect the concerned parts of the physical barrier or of the obstacle.

The computing resources are used to determine the relative position of the concerned parts of the physical barrier or of the obstacle in relation to the mobile robot, as a function of the value of the detected power,

In a dynamic manner, it is thus possible, as the mobile robot moves:
to determine the geometrical data (angles and lengths, etc.) characterising the geometry of the obstacles or of the physical barrier, and/or
to construct a map of the complex surface.

Finally, it should be noted that the invention also relates to any application of the process according to one of the previous implementations, or to a system in any of the foregoing implementations, to the implementation of a robot for the treatment of flat and/or warped surfaces, to a robot for the treatment of wild or cultivated land, to a vacuum-cleaning robot, to a robotic lawn mower, to a robot for washing horizontal or inclined walls, particularly of the glazed or ceiling or roof type, and to a robot for the decontamination of complex contaminated surfaces.

### ADVANTAGES OF THE INVENTION

The implementation of a process or of a system according to the invention by means of a mobile robot has the advantage of enabling the latter to scan a surface exhaustively, that is to effect a scan of the whole of this surface which is adequate in relation to the treatment of the surface covered, with use being made by this robot of low-cost relative position sensors.

In fact, the sensor error included in the location of the robot corresponds to the error associated with the scanning of a strip.

Now, the error associated with the scanning of a strip is less than the scanning error for the whole of the surface that includes this strip, so that, from the movement data of the robot (number of wheel revolutions and changes of direction), it is possible to compensate for the errors in the sensors at each encounter with a physical barrier and/or an obstacle.

In other words, by limiting the scan to successive strips, each strip being of small dimension in relation to the complex surface, and of appropriate shape, it is possible to obtain a precise location in each strip using low-cost location resources, in order to effect an exhaustive scan of the latter

### THE FIGURES

Other characteristics and advantages of the invention will appear from the description of this invention, provided below by way of information only and in a non-limited manner, with reference to the attached figures in which:

FIG. 1 is a diagram relating to the scanning trajectory of a robot over a complex surface, delimited by a regular physical barrier,

FIG. 2 is a diagram of an algorithm for scanning a complex surface according to the invention,

FIGS. 3a, 3b, 3c and 3d are diagrams showing the first scan strips traversed by a robot according to the invention,

FIGS. 4a, 4b and 4c are diagrams of the scanning trajectory of a robot over complex surfaces delimited by irregular physical barriers,

FIG. 5 is a schematic representation of a system used to create a map of a surface to be scanned, and

FIGS. 6a and 6b are schematic representations of calculations of angles between a robot and a part of a physical barrier, obstacle or strip.

### DESCRIPTION OF METHODS FOR IMPLEMENTATION OF THE INVENTION

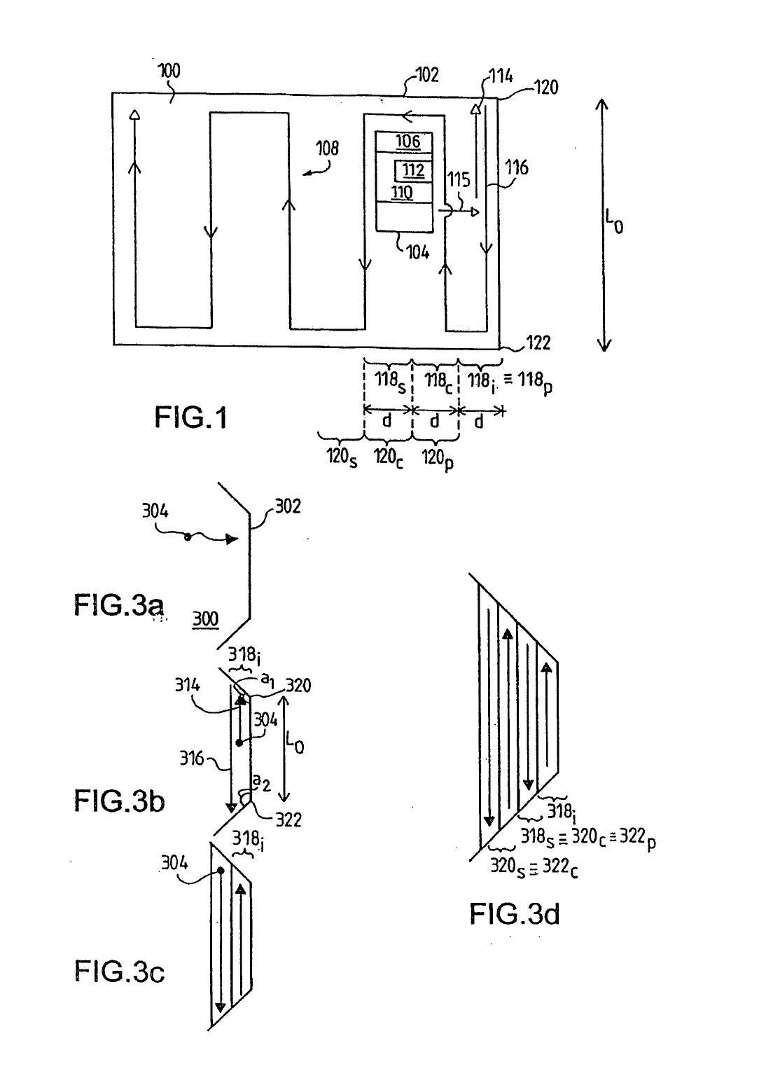

In the description of the invention given below, we are considering a complex surface 100 (FIG. 1), that is one which, for example, may include irregularities and/or variations of gradient, and delimited at least partially by a physical barrier 102 such as a wall or a gap or change of direction in the complex surface.

The nature of this surface, which can be flat and/or warped, varies as a function of the application in which a robot 104 according to the invention is used. Thus, such an application can relate to a robot which is used to treat wild or cultivated land, to a vacuum-cleaning robot, to a robotic lawn mower, to a robot employed to wash horizontal or inclined walls, particularly of the glazed or ceiling or roof type, or indeed to a robot for the decontamination of complex contaminated surfaces.

Furthermore, this surface can include one or more obstacles which, similarly to the physical barrier, limit the movement of the robot requiring to scan this surface, that is requiring to traverse the surface concerned while applying a treatment to the said surface.

This is why we consider as an obstacle any element which prevents the movement of the robot over the whole of the complex surface. Thus, an obstacle can take the form of a physical object or can be a gap or change of direction such as an opening in a roof.

To scan such a surface, the robot 104 includes detection resources 106 used (i) to detect the physical barrier 102 and/or the obstacles and (ii) to supply, at least in part, the geometrical data (angles and lengths) characterising the geometry of the physical barrier and/or (iii) the geometry of the obstacles, and (iv) the geometry of the journey effected by the mobile robot.

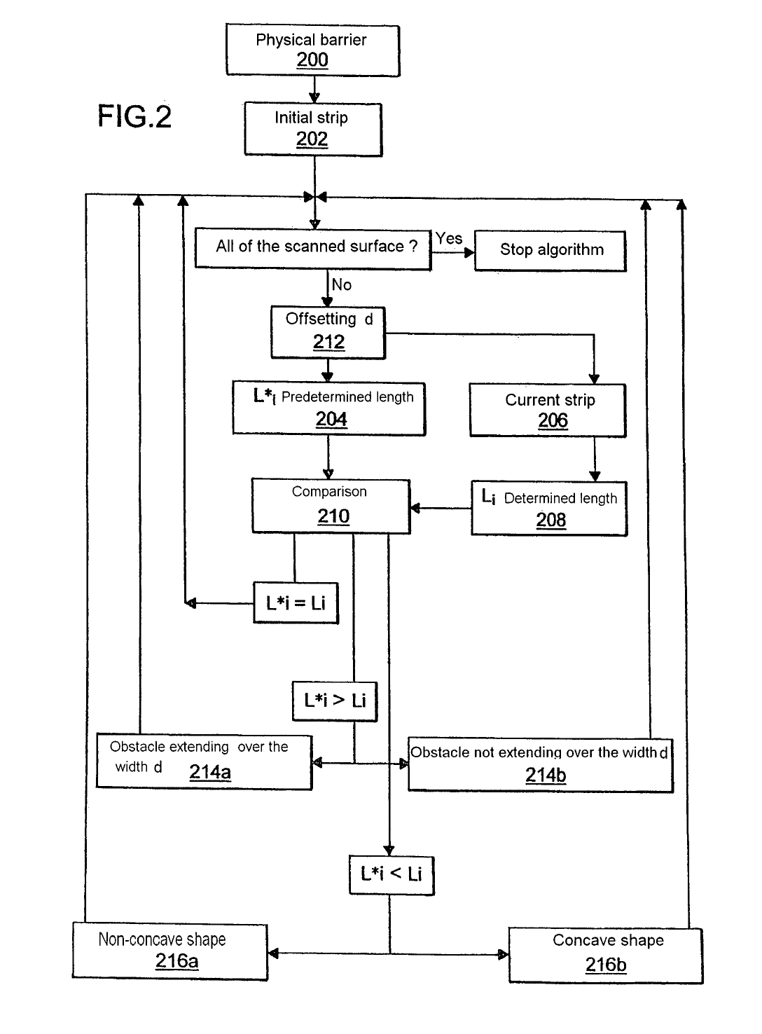

In addition, this robot 104 includes computer processing resources 110 used to control its movements as a function of the data supplied by its detection resources 106, where these computer processing resources 110 include computing resources 112 used to execute an algorithm, described above with reference to FIG. 2.

More precisely, this algorithm includes the following stages:

a) a stage 200 to control the movement 115 of the mobile robot 104 to the physical barrier 102 after detection of the latter by its detection resources 106,

b) an initial stage 202 which, according to a first approach, orders the mobile robot (i) to traverse, in a first direction 114, at least in part, an initialisation strip 118ᵢ running along the physical barrier 102 (scanning the strip), until the physical barrier presents an angular rupture 120 whose value is outside the limits of a predetermined range of permitted values, and then (ii) to command the mobile robot to traverse, in its entirety, in the other direction 116 the initialisation strip 118i running along the physical barrier 102 until the latter presents an angular rupture 122 whose value falls outside that of a range of permitted values.

According to a second approach, wherever possible, the stage 202 orders the mobile robot to traverse, in a single run, an initialisation strip 118ᵢ running along at least one part of the physical barrier 102 contained between two angular ruptures 120 and 122 of the physical barrier whose values fall outside the limits of a predetermined range of permitted values.

In these two cases, the computing resources 112 are used during the initial stage to calculate the length L₀ of the initialisation strip 118ᵢ from geometrical data (angles and lengths) supplied by the detection resources 106 and characterising the geometry of the initialisation strip 118ᵢ.

In addition, the computer processing resources 110 are used to execute an iterative process initialised by the journey over the initialisation strip and continuing by the journey over strips which are hereafter described as the previous strip 118ₚ, the current strip 118_{c} and the next strip 118ₛ, with the first previous strip being composed of the initialisation strip 118ᵢ.

The initialisation 118ᵢ, current 118_{c}, previous 118ₚ and following 118ₛ strips have a predetermined width (d, and the computing resources 112 are used (i) to determine the part of the complex surface 100 remaining to be scanned by extracting the parts of the complex surface already scanned and (ii) then updating the geometrical characteristics of the physical barrier 102 delimiting the part of the complex surface remaining to be scanned.

c) the computer processing resources 110 include computing resources 112 which are also used to execute the following stages of the algorithm, namely:

c1) a stage 204 to predetermine the length L*i of the current strip from the geometrical data characterising the geometry of the previous strip,

c2) a stage 206 used to command the mobile robot to traverse the current strip in its entirety running along the previous strip until the current strip presents an angular rupture whose value falls outside the limits of a predetermined range of permitted values.

c3) a stage 208 to determine the length Lᵢ of the current strip 118_{c} from the geometrical data obtained during the journey over this current strip and characterising its geometry,

c4) a stage 210 to compare the predetermined length L*ᵢ with the determined length Lᵢ, so that
if the predetermined length L*ᵢ is more or less equal to the determined length Lᵢ, then stage c5) of the algorithm is executed,
if the predetermined length L*i is greater than the determined length (Lᵢ, it is assumed that an obstacle is present on the current strip, and stage c6) of the algorithm is executed, and
if the predetermined length L*i is less than the determined length Lᵢ, it is assumed that the physical barrier comprises a discontinuity in the said current strip and stage c7) of the algorithm is executed, these stages c5), c6) and c7) being detailed above.

Stage c5) includes a stage 212 (i) to command the mobile robot to pass to the next strip by laterally offsetting its trajectory over a distance that is more or less equal to the predetermined width of one of the current strips, and then (ii) to command the mobile robot to traverse the next strip 118ₛ in the direction opposite to that of the current strip, and to command the mobile robot to iterate the algorithm from stage c1).

The former current strip 118_{c}, is then considered to be the new previous strip 120ₚ, while the next strip 118ₛ is now considered to be the new current strip 120_{c}.

c6) Stage 214 breaks down into two options, namely:

a) if the obstacle extends over the width (d) of the current strip, then stage c6) includes a stage (i) to command 214ₐ the mobile robot to pass to the next strip by laterally offsetting its trajectory over a distance that is more or less equal to the predetermined width of one of the current strips, (ii) to command the mobile robot to traverse the next strip in the direction opposite to that of the current strip, and (iii) to command the mobile robot to iterate the algorithm from stage c1).

The former current strip 118_{c} is then considered to be the new previous strip 120ₚ, while the next strip is now considered to be the new current strip 120_{c}.

b) if the obstacle does not extend over the whole width of the current strip 118_{c}, it includes a stage 214_{b} to command the mobile robot to skirt the obstacle by continuing the journey over the current strip, and then a stage to command the mobile robot to iterate the algorithm from stage c3).

Stage c7) concerns control of the mobile robot so that it continues its trajectory over the current strip 118_{c}, by running along the physical barrier 102 following the discontinuity until an angular rupture is encountered whose value is outside the limits of a predetermined range of permitted values. In this case,

if the angular rupture thus encountered corresponds to a peripheral barrier with a concave feature, then stage c7) includes a stage 216b to command the mobile robot to enter into the concave feature, and to iterate the algorithm from stage a), while,

if the angular rupture thus encountered corresponds to a peripheral barrier that does not have a concave shape, then stage c7) includes a stage 216a to command the mobile robot to iterate the algorithm from stage c1).

FIGS. 3a, 3b, 3c and 3d are described above, in order to illustrate in greater detail the operation of a robot according to the invention while scanning the first strips.

As shown in FIG. 3a, a robot 304 (shown by a point for reasons of clarity) which is active on a surface 300 will move, according to the first stage 200 of the algorithm, to a nearby physical barrier 302.

Then (FIG. 3b), the robot 304 performs a first partial scan 314 of the physical barrier until detection of an angular rupture 320 and then a second full scan 316, in a direction opposite to that of the first scan, up to a second physical rupture 322.

By means of these first scans 320 and 322, the robot has determined geometrical parameters such as the length L₀ of the initial strip 318i and the angles α1 and α2 of the physical barrier at the angle ruptures 320 and 322 so that the computing resources of the robot are able to predetermine the length L*ᵢ of the next strip 318ₛ following initial strip, in accordance with stage 204.

From then on, the later scan (FIG. 3c) of this next strip 318ₛ, which becomes the current strip 320_{c}, of the next measurement cycle, is used to determine its length Lᵢ measured in accordance with stage 206 of the algorithm.

By comparing (stage 210) the predetermined length L*ᵢ of this strip with its measured value Lᵢ, it is then possible to check that the robot is following a scan of the surface 300 in strips, if these predetermined and determined lengths are practically equal.

Then (FIG. 3d), the current strip 320_{c} becomes the previous strip 322ₚ in relation to the stage of comparison of the current strip 322_{c} which was previously the next strip 320ₛ.

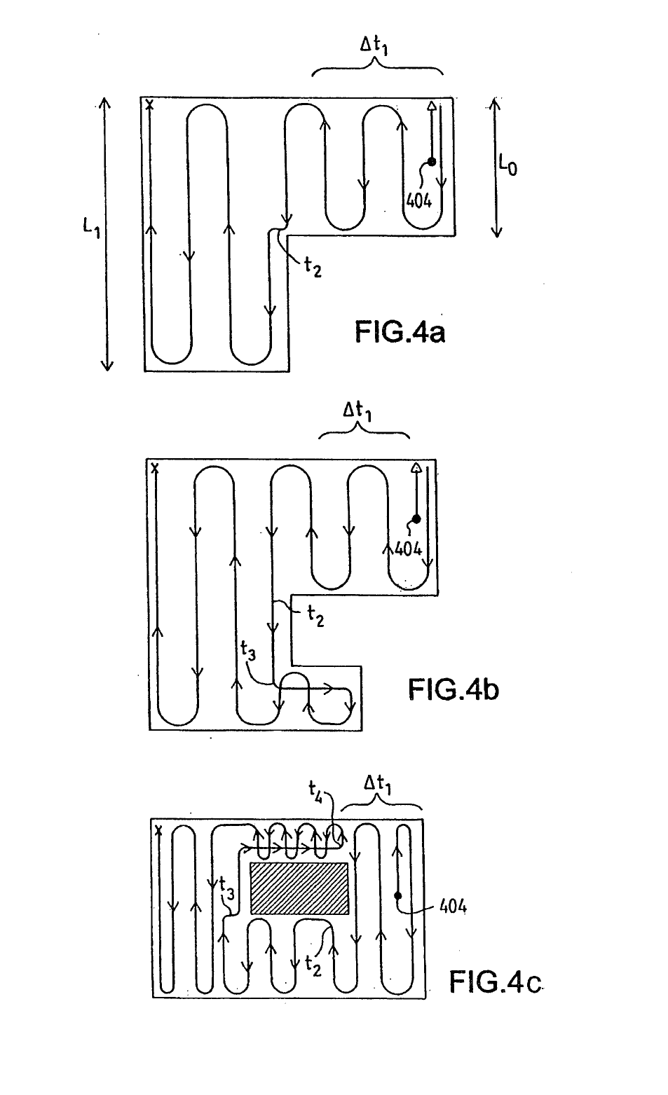

FIGS. 4a, 4b and 4c show cases of scanning where the determined lengths do not match the predetermined lengths.

Thus, FIG. 4a shows an example of scanning such that, in a first stage Δt1, the robot traverses the strips in accordance with stages 204 to 212 of the algorithm, and the measured lengths correspond to predetermined length L0.

At an instant t2 however, the robot detects an obstacle which does not extend over the width of the strip.

From then on, in accordance with stage 214b, the robot 404 continue the scanning of this strip, by determining its length so that it can scan later by following strips of predetermined length L₁.

According to a second example shown in FIG. 4b, the robot scans so that, in a first stage Δt1, the robot traverses strips in accordance with stages 204 to 212 of the algorithm, with measured lengths corresponding to predetermined length L₀.

At instant t2 however, the robot detects the absence of a physical barrier and, in accordance with stage 214b, the robot 404 continues scanning this strip by determining its length as described above.

At instant t3 however, the robot detects a discontinuity and, in accordance with stage 216b, the latter enters into the concave feature and executes the algorithm described with reference to FIG. 2, from stage 200.

Finally, FIG. 4_{c} shows the case where the robot traverses the stages described above in relation to an obstacle 414 located within the surface 400 to be scanned.

In fact, during a time Δt1, the robot traverses the strips in accordance with stages 204 to 212 of the algorithm, with measured lengths corresponding to predetermined length L₀.

And then, from instant t2, the robot detects the obstacle 414 which does not extend over the strip, and so, in accordance with stage 214b, the robot 404 continues scanning this strip by determining its length.

Then at instant t3, the robot detects a discontinuity and, in accordance with stage 216b, the latter enters into the concave feature and executes the algorithm described with reference to FIG. 2 from stage 200.

The computing resources are used to determine the part of the complex surface remaining to be scanned by extracting the parts of the complex surface already scanned and then updating the geometrical characteristics of the said physical barrier delimiting the part of the complex surface remaining to be scanned.

From then on, when the robot reaches a strip which has already been scanned (t4), it moves to a part of the surface which has not yet been scanned.

In fact, at this stage, it should be emphasised that, in this implementation of the system including the robot, the computer processing resources are used to determine, at least in part, the geometrical data characterising the geometry of the physical barrier and/or of the obstacles, the geometry of the initialisation strip, of the previous strip, of the current strip, of the next strip, of a map of at least one part of the complex surface, of the obstacles and the physical barriers.

In one implementation of the system, the processing resources of treatment also order the mobile robot to pass from the current strip 118_{c} to the next strip 118ₛ by running along the physical barrier over a distance corresponding to the width of a strip, allowing for the local geometrical features of the physical barrier.

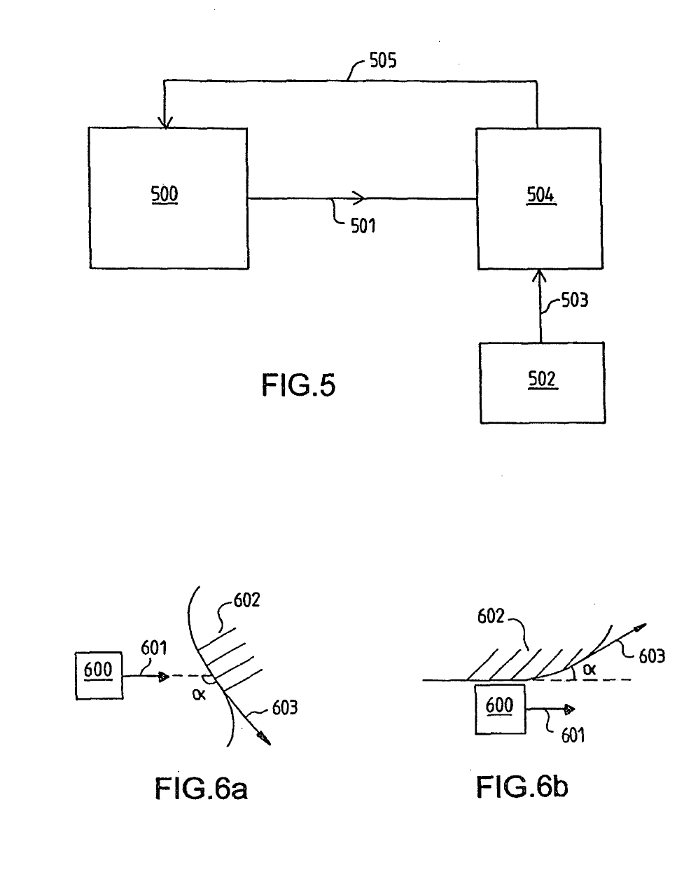

According to one implementation of the system, the computing resources are used to calculate, in a dynamic manner, a map of the complex surface from data supplied by the detection resources while scanning the complex surface, as described above with reference to FIG. 5.

FIG. 5 shows a database 500, which includes pre-established information 501 relating to the geometry of a surface to be scanned, as well as a base 502 which records the information 503 relating to the measurements effected by the different sensors and probes of the robot.

By comparing this pre-established 501 and measured 503 data, a comparator 504 is able to update the information 501 recorded in the base 500, in order, for example, to store the movement of an obstacle in relation to a previous scan of the surface.

In one implementation of the system, described in detail in patent application FR 01/01065, entitled “Process and device for obstacle detection and for distance measurement by infrared radiation”, submitted on 26 Jan. 2001 on behalf of Wany SA (France), and published on 2 Aug. 2002, the detection resources can include:

an infrared radiation emitter,

an infrared radiation receiver detecting the infrared radiation reflected by the concerned parts of the physical barrier or of the obstacle.

The computer processing resources can gradually vary the power of the infrared radiation emitted by the said emitter up to a power that is sufficient to detect the concerned parts of the physical barrier or obstacle.

The computing resources are used to determine the relative position of the concerned parts of the physical barrier or obstacle in relation to the mobile robot as a function of the value of the detected power, in such a manner that it is then possible, in a dynamic manner, as the robot is moving over the surface:
(i) to determine the geometrical data (angles, length) characterising the geometry of the obstacles or of the physical barrier, and/or
(ii) to construct a map of the complex surface.

Finally, it should be noted that the invention also relates to any application of the process according to one of the preceding implementations, or to a system according to one of the previous claims, to the implementation of a robot for the treatment of flat and/or warped surfaces, to a robot for the treatment of wild or cultivated land, to a vacuum-cleaning robot, to a robotic lawn mower, to a robot employed to wash horizontal or inclined walls, particularly of the glazed or ceiling or roof type, or to a robot for the decontamination of complex contaminated surfaces.

1. A process used to scan a complex surface (100) delimited at least in part by a physical barrier (102, 302) and/or obstacles (414), where the said process includes the following stages:
a) a stage to detect the said physical barrier (102, 302) and/or the said obstacles (414),
b) an initial stage whose purpose is either:
to traverse, in a first direction (114, 314), at least in part, an initialisation strip (118ᵢ, 318ᵢ)running along the said physical barrier (102, 302) and scanning the said strip (118ᵢ, 318ᵢ), until the said physical barrier (102, 302) presents an angular rupture (120, 320) whose value is outside the limits of a predetermined range of permitted values, and then
to traverse (200) in the other direction (116, 316), in its entirety, the said initialisation strip (118ᵢ, 318ᵢ) running along at least one part of the said physical barrier until the said physical barrier presents an angular rupture (122, 322) whose value is outside the limits of a predetermined range of permitted values;
or, wherever possible, to traverse, in a single run, a initialisation strip running along at least one part of the said physical barrier contained between two angular ruptures of the said physical barrier whose values fall outside the limits of a predetermined range of permitted values,
where said process also includes, during the said initial stage, a stage (202) to calculate the length (L₀) of the initialisation strip from the geometrical data (angles and lengths) characterising the geometry of the initialisation strip;
where the said process executes an iterative process initialised by the journey over the said initialisation strip and continuing by the journey over strips hereafter successively called the previous strip (118ₚ, 120ₚ, 322ₚ), the current strip (118_{c}, 120_{c}, 320_{c}, 322_{c}) and the next strip (118ₛ, 120ₛ, 320ₛ, 322ₛ), where the first previous strip (118ₚ, 318ₚ) is composed of the said initialisation strip (118ᵢ, 318ᵢ), where the said initialisation strip (118ᵢ, 318ᵢ), the said current strips (118_{c}, 120_{c}, 320_{c}, 322_{c}), the said previous strips (118ₚ, 120ₚ, 322ₚ) and the said next strips (118ₛ, 120ₛ, 320ₛ, 322ₛ) have a predetermined width (d),
with the said process being such that the parts of the complex surface scanned during the stages preceding the current stage are assumed to be located within the physical barrier delimiting the complex surface;
c) where the said process also includes the following successive stages:
c1) a stage (204) to predetermine the length (L*ᵢ) of the said current strip from the geometrical data characterising the geometry of the said previous strip,
c2) a stage (206) to traverse, the said current strip in its entirety running along the said previous strip until the said current strip presents an angular rupture whose value is outside the limits of a predetermined range of permitted values,
c3) a stage (208) to determine the length (Lᵢ) of the said current strip from the geometrical data obtained during the journey over the said current strip and characterising the geometry of the said current strip,
c4) a stage (210) to compare the predetermined length (L*ᵢ) with the determined length (Lᵢ), so that:
if the predetermined length (L*ᵢ) is more or less equal to the determined length (Lᵢ), then stage c5) of the process is implemented,
if the predetermined length (L*ᵢ) is greater than the determined length (Lᵢ), it is assumed that an obstacle is present on the current strip, and stage c6) of the process is implemented,
if the predetermined length (L*ᵢ) is less than the determined length (Lᵢ), it is assumed that the physical barrier comprises a discontinuity in the said current strip, and stage c7) of the process is implemented,
c5) a stage (212) to pass to the next strip by laterally offsetting the trajectory over a distance that is more or less equal to the predetermined width (d) of one of the said current strips,
a stage to traverse the next strip in the direction opposite to that of the current strip,
a stage to iterate the process from stage c1), as many times as necessary in order to scan the complex surface, where the former current strip is considered to be the new previous strip while the next strip is now considered to be the new current strip,
c6)
if the obstacle extends over the width (d) of the current strip, then stage (241a) is used to pass to the next strip by laterally offsetting the trajectory over a distance that is more or less equal to the predetermined width (d) of one of the said current strips,
a stage to traverse the next strip in the direction opposite to that of the current strip,
a stage to iterate the process from stage c1), as many times as necessary in order to scan the complex surface, the former current strip now being considered to be the new previous strip while the next strip is now considered to be the new current strip,
if the obstacle does not extend over the whole width (d) of the current strip,
a stage (214b) to skirt the obstacle by continuing the journey over the current strip,
a stage to iterate the process from stage c3), as many times as necessary in order to scan the complex surface,
c7) a stage to continue the journey over the current strip (118_{c}, 120_{c}, 320_{c}, 322_{c}), running along the physical barrier or the obstacle and following the discontinuity until an angular rupture is encountered whose value is outside the limits of a predetermined range of permitted values,
if the angular rupture thus encountered corresponds to a peripheral barrier, particularly a physical barrier or an obstacle with a concave shape, then a stage (216b) to enter into the said concave feature and to iterate the process from a) as many times as necessary in order to scan the complex surface,
if the angular rupture thus encountered corresponds to a peripheral barrier, particularly a physical barrier or an obstacle that does not have a concave feature, then a stage (216a) to iterate the process from stage c1) as many times as necessary in order to scan the complex surface.

2. A process according to claim 1; where the said process also includes a stage for passing from the current strip (118_{c}, 120_{c}, 320_{c}, 322_{c}) to the next strip (118ₛ, 120ₛ, 320ₛ, 322ₛ) running along the physical barrier over a distance corresponding to the width of a strip and allowing for the local geometrical features of the physical barrier.

3. A process according to one of claims 1 or 2; where said geometrical data characterises the geometry of the physical barrier and/or obstacles, the geometry of the initialisation strip (118ᵢ, 318ᵢ), of the previous strip (118ₚ, 120ₚ, 322ₚ), of the current strip (118_{c}, 120_{c}, 320_{c}, 322_{c}), of the next strip (118ₛ, 120ₛ, 320ₛ, 322ₛ) can be deduced, at least in part, from a map of at least one part of the complex surface, the obstacles and the physical barriers.

4. A process according to claim 3, where the said map of the complex surface (100), the obstacles (414) and the physical barriers is created, in a dynamic manner, while scanning the said complex surface.

5. A system for scanning a complex surface (100) delimited at least in part by a physical barrier (102, 302) and/or obstacles (414), where the said system includes:
a mobile robot (104, 304, 404) which has detection resources (106) that are used to detect the said physical barrier and/or the said obstacles, and to supply, at least in part, the geometrical data (angles and lengths) characterising the geometry of the said physical barrier and/or the geometry of the said obstacles, as well as the geometry of the journey effected by the said mobile robot,
where the said robot (104, 304, 404) includes computer processing resources (110) which are used to control the movements of the said mobile robot as a function of the data supplied by the said detection resources,
where the said computer processing resources (110) include computing resources (112) used to execute an algorithm that includes the following stages:
a) a stage (200) to control the movement of the said mobile robot (104, 304, 404) up the said physical barrier, after detection of the latter by the said detection resources,
b) an initial stage
either
to command the said mobile robot to traverse, in a first direction (114, 314), at least in part, an initialisation strip (118ᵢ, 318ᵢ) running along the said physical barrier (scanning the said strip), until the said physical barrier presents an angular rupture (120, 320) whose value is outside the limits of a predetermined range of permitted values, and then
to command the said mobile robot to traverse, in the other direction (116, 316), in its entirety, the said initialisation strip (118ᵢ, 318ᵢ) running along at least one part the said physical barrier until the said physical barrier presents an angular rupture (122, 322) whose value falls outside the limits of a predetermined range of permitted values,
or, wherever possible, to command the said mobile robot to traverse, in a single run, an initialisation strip running along at least one part the said physical barrier contained between two angular ruptures of the said physical barrier whose values fall outside the limits of a predetermined range of permitted values,
where the said computing resources are also used during the said initial stage to calculate the length (L₀) of the initialisation strip (118ᵢ, 318ᵢ) from the geometrical data (angles and lengths) supplied by the said detection resources and characterising the geometry of the initialisation strip;
where the said computer processing resources (110) are used to execute an iterative process initialised by the journey over the said initialisation strip and continuing with the journey over strips hereafter described as the previous strip (118ₚ, 120ₚ, 322ₚ), the current strip (118_{c}, 120_{c}, 320_{c}, 322_{c}) and the next strip (118ₛ, 120ₛ, 320ₛ, 322ₛ), where the first previous strip (118ₚ, 120ₚ, 322ₚ) is composed of the said initialisation strip (118ᵢ, 318ᵢ),
where the said initialisation strip (118ᵢ, 318ᵢ), the said current strips (118_{c}, 120_{c}, 320_{c}, 322_{c}), the said previous strips (118ₚ, 120ₚ, 322ₚ) and the said next strips (118ₛ, 120ₛ, 320ₛ, 322ₛ) have a predetermined width (d),
and where the said computing resources (112) are used to determine the part of the complex surface remaining to be scanned by extracting the parts of the complex surface already scanned and then updating the geometrical characteristics of the said physical barrier delimiting the part of the complex surface remaining to be scanned,
c) where the said computer processing resources include computing resources which are also used to execute the following stages of the said algorithm:
c1) a stage (204) to predetermine the length (L*ᵢ) of the said current strip from the geometrical data characterising the geometry of the said previous strip,
c2) a stage (206) to command the mobile robot to traverse the said current strip in its entirety, running along the said previous strip until the said current strip presents an angular rupture whose value is outside the limits of a predetermined range of permitted values,
c3) a stage (208) to determine the length (Lᵢ) of the said current strip from the geometrical data obtained during the journey over the said current strip and characterising the geometry of the said current strip,
c4) a stage (210) to compare the predetermined length (L*ᵢ) with the determined length (Lᵢ), so that:
if the predetermined length (L*ᵢ) is more or less equal to the determined length (Lᵢ), then stage c5) of the algorithm is executed,
if the predetermined length (L*ᵢ) is greater than the determined length (Lᵢ), it is assumed that an obstacle is present on the current strip, and then stage c6) of the algorithm is executed.
if the predetermined length (L*ᵢ) is less than the determined length (Lᵢ), it is assumed that the physical barrier comprises a discontinuity in the said current strip and so stage c7) of the algorithm is executed,
c5) a stage (212) to command the mobile robot to pass to the next strip by laterally offsetting its trajectory over a distance that is more or less equal to the predetermined width (d) of one of the said current strips,
a stage to command the mobile robot to traverse the next strip in the direction opposite to that of the current strip,
a stage to command the mobile robot to iterate the algorithm from stage cl, with the former current strip now being considered to be the new previous strip, while the next strip is now considered to be the new current strip,
c6)
if the obstacle extends over the width (d) of the current strip, then stage (214a) to command the mobile robot to pass to the next strip by laterally offsetting its trajectory over a distance that is more or less equal to the predetermined width (d) of one of the said current strips,
a stage to command the mobile robot to traverse the next strip in the direction opposite to that of the current strip,
a stage to command the mobile robot to iterate the algorithm from stage c1), with the former current strip now being considered to be the new previous strip, while the next strip is now considered to be the new current strip,
if the obstacle does not extend over the whole width (d) of the current strip,
then a stage (214b) to command the mobile robot to skirt the obstacle by continuing the journey over the current strip,
a stage to command the mobile robot to iterate the algorithm from stage c3).
c7) a stage to command the mobile robot to continue the journey over the current strip, running along the physical barrier following the discontinuity until an angular rupture is encountered whose value is outside the limits of a predetermined range of permitted values,
if the angular rupture thus encountered corresponds to a peripheral barrier that has a concave shape, then a stage (216b), to command the mobile robot to enter into the said concave feature and to iterate the algorithm from a)
if the angular rupture thus encountered corresponds to a peripheral barrier that does not have a concave shape, then a stage (216a) to command the mobile robot to iterate the algorithm from stage c1).

6. A system according to claim 5; where the said processing resources (110) also command the mobile robot to pass from the current strip to the next strip, running along the physical barrier over a distance corresponding to the width of a strip, allowing for the local geometrical features of the physical barrier.

7. A system according to one of claims 5 or 6; where the said computer processing resources (110) are used to determine the said geometrical data characterising the geometry of the physical barrier and/or the obstacles, and the geometry of the initialisation strip, the previous strip the current strip, and the next strip, by deducing these, at least in part, from a map of at least one part of the complex surface, of the obstacles and of the physical barriers.

8. A system according to claim 7; where the said computing resources are used to create, in a dynamic manner, the said map of the complex surface from data supplied by the said detection resources while scanning the said complex surface.

9. A system according to any one of claims 5 to 8; where the said detection resources include:
an infrared radiation emitter,
an infrared radiation receiver detecting the infrared radiation reflected by the concerned parts of the physical barrier or the obstacle;
where the said computer processing resources are used to gradually vary the power of the infrared radiation emitted by the said emitter up to a power that is sufficient to detect the concerned parts of the physical barrier or obstacle, where the said computing resources are used to determine the relative position of the concerned parts of the said physical barrier or of the said obstacle in relation to the said mobile robot as a function of the said value of the detected power,
so that it is then possible, in a dynamic manner, as the robot is moving over the surface:
to determine the geometrical data (angles and lengths) characterising the geometry of the obstacles or of the physical barrier, and/or
to construct a map of the complex surface.

10. Application of the process according to claims 1 to 4, or of the system according to claims 5 to 9, to the implementation of a robot for the treatment of flat and/or warped surfaces, of a robot for the treatment of wild or cultivated land, of a vacuum-cleaning robot, of a robotic lawn mower, of a robot employed to wash horizontal or inclined walls, particularly of the glazed or ceiling or roof type, or of a robot for the decontamination of complex contaminated surfaces.
